(19) United States
(12) Patent Application Publication
(10) Pub. No.: US 2004/0039497 A1
(43) Pub. Date: Feb. 26, 2004

(54) Aircraft operations information recording and processing system

(75) Inventors: Thomas Paine Wood, Signal Mountain, TN (US); David John Donovan, Hixson, TN (US); Chadwick James Cox, Chattanooga, TN (US); Robert Michael Pap, Chattanooga, TN (US)

Correspondence Address: Janet C. Donovan, 7001 Shallowford Road, Chattanooga, TN, 37421, US

(73) Assignee: Accurate Automation Corporation, Chattanooga, TN

(21) Appl. No.: 10/458,309

(22) Filed: Jun. 11, 2003

Related U.S. Application Data
(60) Provisional application No. 60/387,900, filed on Jun. 13, 2002.

(51) Int. Cl. G05D 1/00; G06F 7/00

(52) U.S. Cl. 701/4; 701/8

(57) ABSTRACT

A method and apparatus to record and process operations information from aircraft for the purpose of improving maintenance processes, improving security, and accident investigation is described. Information recorded from aircraft operations includes equipment operational data, images of people and equipment, and sound information. This digital information that is recorded is a result of, in some cases, sampling an analog signal. In other cases, the digital information is a result of many information processing steps to improve the usefulness of the information while using a minimum quantity of data. This invention includes steps to compress the quantity of data while producing the most useful information. The digital information may be recorded aboard the aircraft in any of several data storage media, or the information may be transmitted from the aircraft, or a combination of storage aboard the aircraft and transmission may be used. The processes to reduce the quantity of data required to accurately represent the original signals and information are required to use transmission means that include limited bandwidth, and to use data storage aboard the aircraft where the storage is limited in size. The invention includes processes to encrypt or “hide” the digital information from an unauthorized individual or agency that comes into possession of the storage module aboard the aircraft or that receives the transmission from the aircraft. This invention includes processes that may be used to modify recorded images so that individuals or equipment that is deemed private are digitally removed from the digital image that is recorded.

### CITED REFERENCES

### U.S. PATENT DOCUMENTS

| | | |
|---|---|---|
| 6,580,450 | June 2003 | Kersting, et al |
| 5,974,349 | October 1999 | Levine |
| 5,742,336 | April 1998 | Lee |
| 5,463,656 | October 1995 | Polivka, et al |
| 5,283,643 | February 1994 | Fujimoto |

### BACKGROUND OF THE INVENTION

It is desirable to record aircraft operations information for many purposes. Information regarding engine operations parameters such as speeds, hours of operation, operating temperatures, and maintenance logs are recorded for the purpose of recommending preventive and corrective maintenance. In addition, such engine operations parameters may be used in the event of an accident to determine the extent to which the engine may be the cause of the accident. Airframe operations parameters such as location (longitude, latitude, and altitude), heading, speed, roll, pitch, and yaw are recorded for the navigational purposes, as well as accident investigation. Verbal communication among the aircraft personnel and also between the aircraft personnel and ground personnel is recorded for accident investigation as well as other flight operations purposes. Most aviation operations data recordings are made for one of two purposes: equipment maintenance and/or accident investigation.

As electronic image technology improves, it has become desirable to record images of operational activities in addition to equipment data and voice communication. It is desirable to record images of flight operations personnel in action, passenger's activities, the baggage area, and equipment both inside of the aircraft and outside of the aircraft. The primary technical obstacle to extensive video recording of aircraft operation is the large amount of data represented by video frames. A high quality audio recording can be accomplished with a data channel having a bandwidth of about 80,000 bytes per second (20,000 Hz×2 samples/Hz×2 bytes/sample.) A traditional color video recording requires about 28,000,000 bytes per second (640×480×3 bytes/pixel×30 frames/second), or about 350 times greater bandwidth for video compared to audio. Some compromises can be made in video recording, such as monochrome instead of color and a lower frame rate such as 10 frames per second. However, even after compromising, a video data stream represents about 50 times more data compared to audio. Storage of such high quantities of data on board an aircraft in crash-hardened memory or transmission of such high quantities of data from an aircraft to the ground using conventional line of sight communications or satellite communications having limited bandwidth is not presently practical.

U.S. Pat. No. 5,283,643 from Fujimoto offers a flight information recording device for small to medium size airplanes where operational parameters are indirectly recorded by using a video camera observing the pilot, instrument panel, and exterior devices such as flaps while recording onto a magnetic tape recorder. It is intended for use on aircraft where expensive Flight Data Recorders (FDR) and Flight Voice Recorders (FVR) are not practical. Such a system has limited capabilities because magnetic tape recording would not survive a crash for accident investigation, and many manual operations are necessary to extract operational data from recorded video to provide a basis for equipment maintenance.

U.S. Pat. No. 5,742,336 from Lee offers an aircraft surveillance and recording system where the video camera signals and audio signals from four or more cameras and microphones are directly modulated onto a carrier signal for transmission to a relay satellite and ultimately to a ground station. Such a system would not be practical due to the extremely high bandwidth requirements of multiple video cameras and microphones. Such a system would require over 100 megahertz of bandwidth for each aircraft. Given that several thousand aircraft can be in-flight simultaneously, many hundreds of gigahertz of satellite bandwidth would be required to support such a system. In addition, privacy issues would require that such communications would be “hidden” or encrypted from public view.

U.S. Pat. No. 5,463,656 from Polivka and Zahm offers a system for communicating a video signal from the ground to an in-flight aircraft through a relay satellite using a compact phased array antenna system on the aircraft. The proposed system does encompass compressed video information, thereby reducing the bandwidth requirement. This invention specifically includes a means to implement a phased array antenna on the surface of the aircraft and a means to process the signals from the phased array antenna to maximize signal to noise ratio (SNR) of the received signal. Such a system may offer a practical solution for many aircraft to simultaneously receive the same broadcast television signal. This may offer broadcast television for in-flight entertainment of passengers. However, this invention is not practical for transmission of unique image and sound information from many in-flight aircraft simultaneously through relay satellites to ground stations because such a large quantity of simultaneous unique full frame rate video would require a bandwidth beyond that presently offered by satellite communications providers.

U.S. Pat. No. 5,974,349 from Levine offers a system for communicating aircraft operations information between in-flight aircraft and a network of ground stations through relay communications satellites. The proposed system is primarily limited to low-bandwidth operational parameters such as equipment status and location and heading. When the information reaches the ground station, it is communicated through a network of ground stations using high-bandwidth fiber optic connections. Such a system would likely require data “hiding” or encryption to be practical.

U.S. Pat. No. 6,580,450 from Kersting et al offers a system for obtaining electronic images from the interior of an aircraft and compressing and storing all images for a recent time period aboard the aircraft, and also transmitting selective images to a communications satellite. The proposed system would be of great utility for surveillance purposes, but is incomplete for purposes of maintenance and safety. Such images would likely be encrypted before either storage or transmission. In addition, images from the exterior of the aircraft would assist in surveillance and operational procedures. Also, non-image data such as digitized audio or maintenance parameters would assist efficient operations.

During the aircraft hijackings of Sep. 11, 2001, ground personnel knew very little about the activities on board the four hijacked airplanes. Additional flight operations information in the hands of ground personnel may have prevented or reduced the losses. Other airplane crashes have been unexplained due to lack of operational information leading up to the crash. On-board flight data recorders have occasionally been unrecoverable or contained incomplete data.

While there are many techniques that offer partial solutions to the need for complex data recording (images, sound, and operational parameter data), no complete solution exists. The data bandwidth exceeds mobile commercial communications channels, and total data storage requirement exceeds the size of crash-hardened memory that is available for a reasonable price, size, and weight allocation.

### SUMMARY OF THE INVENTION

This invention is a system to process and record operational information from an aircraft. Operational information consists of equipment operating parameters, aircraft operating parameters, sound recordings, and visual recordings. Equipment operating parameters includes, but is not limited to, engine speed, temperature, lubrication and fuel and coolant conditions, and maintenance history. Aircraft operating parameters includes, but is not limited to, speed, location (longitude and latitude), altitude, roll, pitch, yaw, and maintenance history. Sound recordings includes, but is not limited to, spoken communications among airplane flight staff, spoken communications between airplane flight staff and passengers, spoken communications between airplane flight staff and ground personnel, and any other sound of equipment such as engines, landing gear raised or lowered, doors opening and closing, and abnormal sounds such as equipment breakage or equipment destruction. Visual recordings include, but are not limited to, images of airplane flight staff activities, images of passenger activities, images of the baggage or storage area of the airplane, and images of the interior and exterior of the airplane. The objective of recording and processing this information is a) to provide a basis for improved security of the airplane, passengers, and flight staff, b) provide a basis for accident investigation, and, c) to provide a basis for improved maintenance operations. Together, these objectives improve safety and at the same time reduce operating cost of air travel.

The proposed system includes many different kinds of sensors to sense both equipment operational conditions and the activities of people on an airplane. The signals may undergo some analog signal conditioning, such as band pass spectral filtering. After the signals are digitized with Analog to Digital (A/D) converters, some digital processing may occur. This can include image enhancement to improve the quality of digitized images. Further information processing may be performed to modify sample rates, compress the memory size required to represent the data in either a “lossy” or “lossless” manner, and encrypt the data using either a public key encryption process or a symmetric key encryption process. Information processing techniques may include, but are not limited to Artificial Intelligence or Neural Network Processing methods.

The output of the aircraft information recording and processing system is data that is either stored aboard the aircraft in crash-hardened memory or transmitted via wireless communications to another location (such as a ground station) to be recorded. Crash-hardened memory is both expensive (in cost per megabyte) and bulky; therefore it is highly desirable to process the sampled signals to maximize the useful information in a given quantity of stored data. This invention includes several signal processing methods that reduce memory requirements.

The digital data and images may be compressed to reduce storage requirements. This may include “lossy” or “lossless” compression techniques. Data is generally compressed using “lossless” techniques and recorded digital images and sound may be compressed using either “lossless” or “lossy” techniques. “Lossless” compression techniques include, but are not limited to, entropy arithmetic coding and wavelet transform mathematical processing to produce a smaller data record that the original, but the smaller record may be decompressed to produce the original record exactly (without data loss.) “Lossy” compression techniques include, but are not limited to, discrete cosine transform and wavelet transform where the original digital record is processed to produce a smaller record for storage or transfer, but upon decompression the restored record is not identical to the original. In the case of recorded digital images or sound, the goal of the “lossy” compression is to produce a restored record with unperceivable differences from the original.

The digitized and processed recordings may be encrypted for storage in memory or for transmission. Encryption permits the data to be “hidden” from viewers that are not authorized to observe the recordings. The encryption process may be a standardized process such as Data Encryption Standard (DES) with a 56-bit key, or the Advanced Encryption Standard (AES) with 128, 192, or 256-bit key. Larger keys provide greater security. Given a known message block, many more trials are required to deduce the key for a 128-bit key encryption process than for a 56-bit key encryption process. Through the use of encryption, recordings stored in crash-hardened memory cannot be viewed by persons finding the crash-hardened memory that do not have the decryption key. Likewise, recordings that are transmitted with encryption and received by persons that do not have the decryption key cannot be viewed.

This invention includes the ability to intentionally exclude certain individuals and equipment from the field of view of the camera. It may be desirable for an individual to have their image intentionally removed or “blanked” from the series of digital images that are recorded. This may be done to protect the privacy of individuals, to avoid recording images of equipment deemed classified for military or security purposes, or other legal or contractual terms. In particular, the digital image captured in the cockpit of the aircraft showing the back of the pilot and/or co-pilot may be processed to “scramble” or remove the images of these people. This processing feature may be turned on and off by a manual operation from a aircraft staff member or ground personnel, or it may be turned on and off by an automatic process possibly including an Artificial Intelligence operation.

The camera or cameras that capture images may be of either analog video type, including, but not limited to, NTSC, RS-170, PAL, or other conventional video products. The camera or cameras may also be of a digital imaging type where the output is a stream of digital data that directly flows into a computer or processor for modification, storage, or transmission. The set of imaging cameras may be a combination of one or more analog video cameras and one or more digital cameras. Any individual camera may be sensitive to either visible or invisible light or both visible and invisible light. Any individual camera may be sensitive to non-visible light components such as X-Rays and infrared light. Any individual camera may have a monochromatic output or a multi-spectral (color) output. Any individual camera may have low capability to resolve image details. Any individual camera may have high capability to resolve image details.

The information recorded and processed on the airplane may be stored on the airplane for later use or transmitted or the information may be both stored and transmitted. Information stored on the airplane may be stored in either crash-hardened memory or stored in conventional (non-crash-hardened) memory. Conventional memory may be magnetic disk, semiconductor, magnetic tape, or any other commercially available memory device. Information transmitted may be transmitted within the airplane or to a destination outside of the airplane. Information transmitted within the airplane may be transmitted using wireless electromagnetic waves or optical techniques such as modulated infrared transmitting and receiving devices. Information transmitted to a destination outside of the airplane will likely use wireless electromagnetic waves including, but not limited to, line-of-sight processes such as point-to-point AM and FM, or the transmission means may include one or more relay satellites.

If information is transmitted between an aircraft and a ground station, the information may be deposited on the ground at a central repository, or it may be distributed to multiple storage points.

### BRIEF DESCRIPTION OF THE DRAWINGS

FIG. 1 shows a communications of recorded information between an aircraft 1 and a ground station 3 with the transmission passing through one or more relay satellites 2. This communications process is practical in a situation where no line-of-sight wireless telecommunications is possible. The communications from the aircraft to the ground station may include recorded or processed data used for maintenance or security purposes. The communications from the ground station to the aircraft may include control information such as which cameras to operate or which data sensors are to be utilized at a given time. If adequate bandwidth is available, communications of image data or audio data from the ground station to the aircraft may be included. However, image and audio information from the ground to the aircraft may not be required to constitute a complete maintenance or security information system. If adequate bandwidth is available, the communications from the ground station to the aircraft may include images and audio data for the purpose of in-flight entertainment. Relay satellite telecommunications, such as depicted in FIG. 1, may include passing the data through multiple satellites before communicating with the ground.

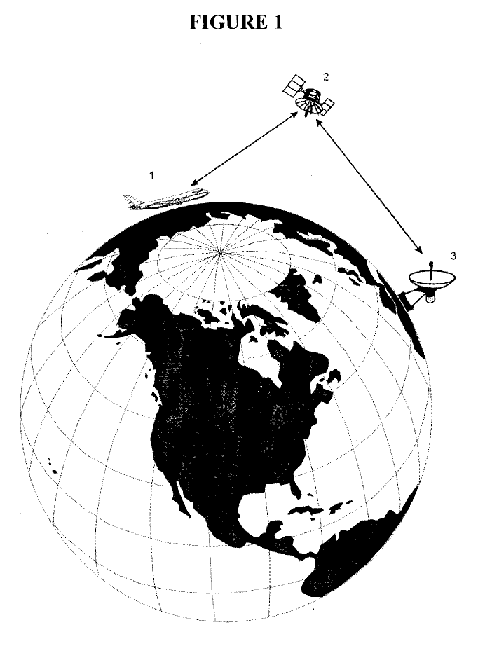

FIG. 2 shows a communications of recorded information between an aircraft 4 and a ground station antenna 5. This communications process is practical in a situation where line-of-sight wireless telecommunications is possible. The communications from the aircraft to the ground station may include recorded or processed data used for maintenance or security purposes. The communications from the ground station to the aircraft may include control information such as which cameras to operate or which data sensors are to be utilized at a given time. If adequate bandwidth is available, communications of image data or audio data from the ground station to the aircraft may be included. However, image and audio information from the ground to the aircraft may not be required to constitute a complete maintenance or security information system. If adequate bandwidth is available, the communications from the ground station to the aircraft may include images and audio data for the purpose of in-flight entertainment.

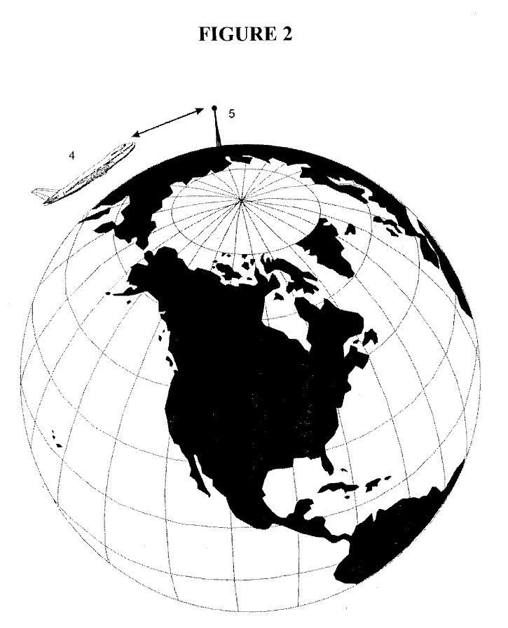

FIG. 3 shows a communications of recorded information between an aircraft 6 and another aircraft 7 through line-of-sight telecommunications. In this situation, the recorded information from each aircraft may be transmitted to the other aircraft. Each aircraft may transmit its full set of images and sound information to the other aircraft. Many aircraft may exchange full operations information, including images and sound, with many other aircraft if adequate bandwidth is available.

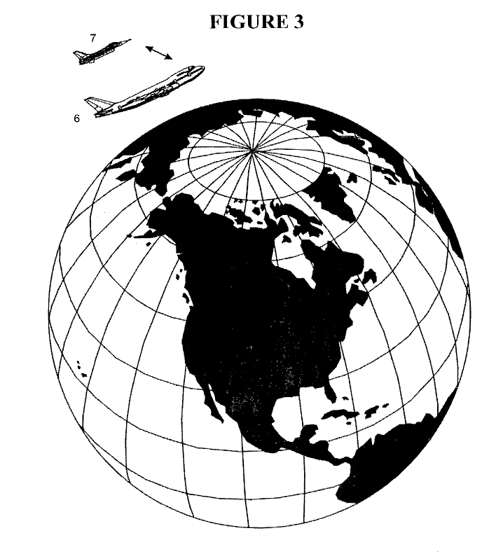

FIG. 4 shows a communications of recorded information between an aircraft 8 and another aircraft 9 through a relay satellite 16. This communications process is practical in a situation where line-of-sight wireless telecommunications is not possible. In this situation, the recorded information from each aircraft may be transmitted to the other aircraft. Each aircraft may transmit its full set of images and sound information to the other aircraft. Many aircraft may exchange full operations information, including images and sound, with many other aircraft if adequate bandwidth is available.

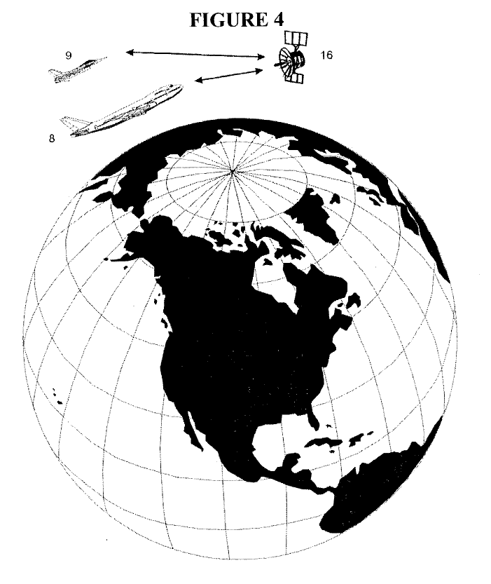

FIG. 5 shows a floor plan of an aircraft 10, with several cameras and sound sensors placed to observe the actions of people and equipment. Sensor 11 consists of an image sensor or a sound sensor or both an image sensor and a sound sensor. Sensor 11 is located in the cockpit of the aircraft, and is used to observe the actions in the cockpit including, but not limited to, the aircraft flight staff, instruments, the front windscreen, and persons entering and leaving the cockpit. Sensor 17 consists of an image sensor or a sound sensor or both an image sensor and a sound sensor. Sensor 17 is located in the cargo compartment and is used to observe the actions of cargo being loaded and unloaded, and to observe cargo (including passenger's baggage) during flight. Information from sensor 17 could be used following a crash to determine if an explosion occurred in the baggage compartment. Sensors 18 and 19 consists of an image sensor or a sound sensor or both an image sensor and a sound sensor. Sensors 18 and 19 are located on the exterior of the aircraft, and are used to observe the wings or fuselage or both wings and fuselage of the aircraft during flight. Sensors 18 and 19 could be used by the aircraft flight staff or designated ground staff (if recorded information is transmitted to the ground) to observe external malfunctions during a flight. Sensors 12, 13, 14, and 15 consists of an image sensor or a sound sensor or both an image sensor and a sound sensor. Sensors 12, 13, 14, and 15 are used to observe the actions of people and equipment located in the passenger compartment of the aircraft.

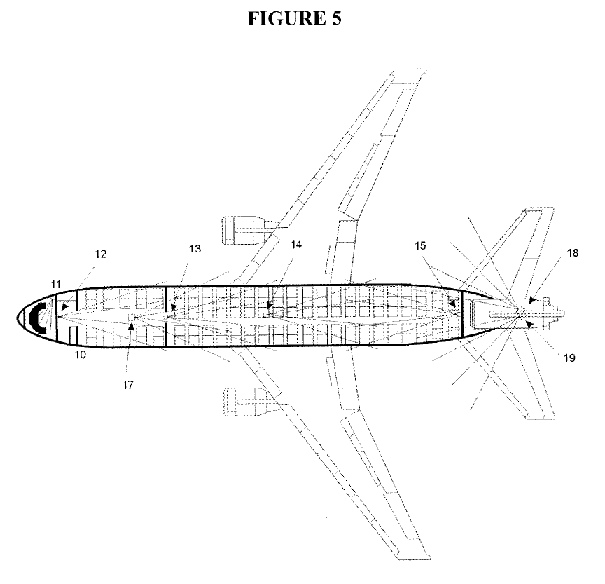

FIG. 6 shows the functions of the Aircraft Operations Information Recording and Processing System. Vision sensor(s) 20 create image signals based on the optical characteristics within the field of vision of the camera(s). Sound sensor(s) 21 create signals based on the sounds present around any microphone(s). Engine senor(s) 22 create signals based on the operational parameters of the engine(s). These signals may include speed, temperature, and fuel and coolant characteristics. Aircraft sensor(s) 23 create signals based on the operational characteristics of the aircraft. These signals may include aircraft speed, location, altitude, roll, pitch, and yaw. These signals 20, 21, 22, and 23 are converted to digital data by Analog to Digital converters 24. The various digital data streams may be further processed with one or more Digital Signal Processing steps 25. In some instances the Digital Signal Processing steps are not present (such as direct recording of a sampled temperature sensor), and in other instances, the Digital Signal Processing steps are extensive (such as spectral analysis and enhancement of sound signals.) The data is then available for compression by data compressors 26. This can be “lossy” compression techniques where the restored data is identical to the original data, or it can be “lossless” compression techniques where the restored data is different from the original data, but the differences are imperceptible. Image data may be further processed by removing or “blanking” regions of the field of view for privacy purposes. The entire recording data set may be encrypted by an encryption device 28. This prevents any unauthorized person or agency from viewing the recording without the decryption key. Recorded data may be stored aboard the aircraft in memory 29. This memory may be designed to withstand a crash or the memory may be of conventional design techniques. The recorded data may be transmitted by a transmit module to a destination outside of the aircraft or aboard the aircraft. Many of these data processing modules 25, 26, 27, 28, 29, and 30 may or may not be present, depending upon the application.

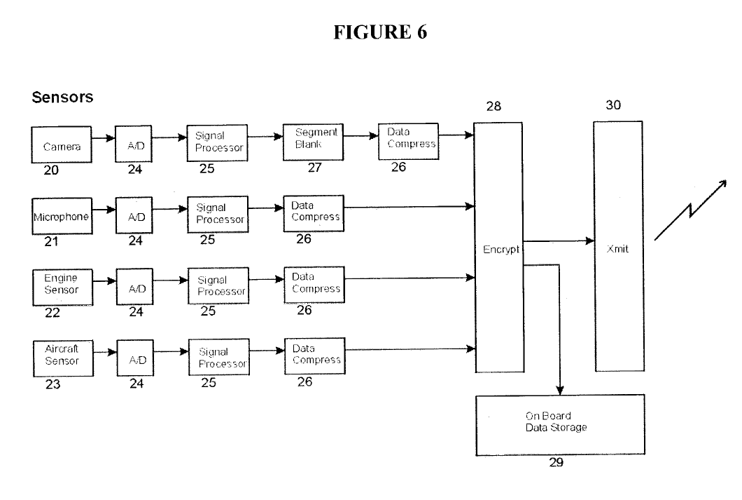

FIG. 7 shows the data encryption process. The Original Recording 31 is processed through the Encryption Process 32 to produce the Encrypted Data 34. The Encryption Process 32 uses the Encryption Key 33 to calculate the data of the Encrypted Data 34. The Encrypted Data 34 is vastly different from the Original Recording 31 to the point that the Encrypted Data 34 is completely unintelligible. The Encrypted Data 34 may be transmitted or exchanged between users in a public context without concern that anyone possessing the Encrypted Data 34 can deduce any portion of the Original Recording 31. The Encrypted Data 34 can be processed by the Decryption Process 36 to produce the Reconstructed Original Recording 37 if the device performing the Decryption Process 36 has the correct Decryption Key 35. Without the correct Decryption Key 35, the Original Recording 31 cannot be reconstructed if one has the Encrypted Data 34 and a device to perform the Decryption Process 36.

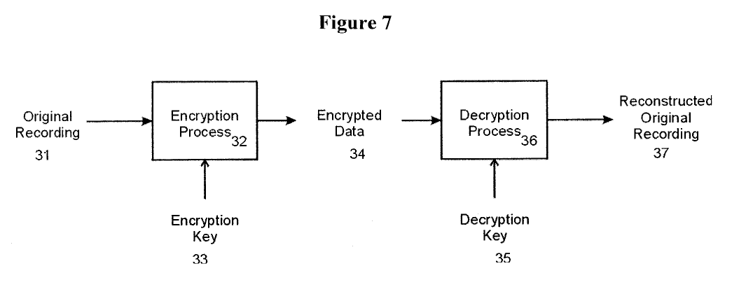

### PREFERRED EMBODIMENT OF THE INVENTION

The aircraft operations information recording and processing system uses many types of sensors to obtain information about the operation of the aircraft. These sensors fall into four major categories: image sensors, sound sensors, engine sensors, and aircraft sensors.

Image sensors are generally electronic cameras 20. This includes digital cameras and analog (video) cameras. These cameras have semiconductor optical sensors that are two-dimensional arrays of sensor elements where each sensor element (pixel) is capable of producing a current or voltage based on the light energy that strikes it. An array of photosensitive elements is integrated in a way that individual element signals can combine to provide a representation as a digital or analog signal that represents the light energy that strikes the area of the array. A lens is placed in front of the sensor array so that a scene is focused onto the sensor array. The signals generated by the sensor array are representative of the scene focused onto the sensor array. If an image is collected from the sensor array several times per second, the sequence of images represent the full motion of the activity in the scene observed by the camera.

Such cameras are available from many manufacturers with a wide range of capabilities. Cameras may be used to implement this invention that represents the full human visible spectrum of colors. Such cameras could be used to observe the size, shape, and color of clothing, lighting conditions, seats, wall coverings, carpets, etc. Alternatively, visible monochrome cameras may be used that indicate size and shape of objects, as well as light intensity, but without color information. Cameras may be used that are primarily sensitive to light of a spectral quality that is not normally visible to humans. This includes light in the infrared and also in the ultraviolet regions. These light spectra are just above and just below human wavelength sensitivities, respectively. In some situations, light in these wavelengths emitted by or reflected by objects in the field of view of a camera contains very useful information for evaluating activities. In situations where ambient light level is very low or nonexistent, there is no light to reflect off of objects to be focused on the photo sensor. In such cases, infrared light may be emitted by objects and collected on a photo sensor sensitive to infrared light.

Cameras 20 have many different electrical interfaces. Analog electronic cameras have industry standard interfaces such as NTSC, PAL, and RS-170. Typically these are coaxial cables with 75 ohm impedance. Digital cameras have industry standard interfaces such as IEEE 1394, USB, and LVDT. These are typically multi-conductor cables with distance limitations. Also, either analog or digital cameras may have proprietary electrical interfaces.

This invention uses analog electrical cameras in a manner where the analog signal is converted to a sequence of digital values prior to recording by Analog to Digital Converters (A/D) 24. Digital electrical cameras have A/D converters built-in. The conversion from analog to digital for analog electronic cameras is done by sampling the analog camera signal at a fixed period.

Sound is sensed by microphones 21 and transformed into information that is useful to this recording and processing system. Microphones are usually devices that convert sound energy to analog electrical signals. Microphones are usually passive analog electrical devices, meaning that the sound sensor requires no external power source. The sound energy is transformed into a low-level electrical signal. The low-level analog signal from a microphone is amplified and perhaps filtered (low-pass bandwidth limited) prior to A/D conversion 24. Microphones may be located to receive spoken sounds by a single individual or microphones may be located to receive sounds from a wider area including conversation between several people. Individual microphones may be mounted on an apparatus worn by aircraft flight staff that may include headphones and microphone for that individual or some other device for converting sound energy into an electrical signal. Alternatively, microphones may have a wide angle of sound reception and mounted in a location where conversation and other sounds of people interacting are available.

Engine sensor devices 22 are used to sense the activity of the engine(s) of an aircraft. These sensors are usually analog devices sensing parameters such as speed, vibration, and temperature. This may include sensing the characteristics of fuel, coolant, lubricant, or other substance related to engine operation. Engine sensors may be analog devices that convert temperature or pressure into a low-voltage analog signal. Such sensors may have direct control over an engine without the action of this information recording and processing system, such as the situation where low lubricant pressure may control the fuel flow or ignition and cause the engine to stop. Also, an air flow sensor in the fuel delivery system may control ignition timing. In such cases, sensors are present for the purpose of efficient engine operation independent of this information recording and processing system. However, the signals from such sensors may be available to the information recording and processing system. Low-level analog sensor signals are usually amplified and then converted to digital values by A/D converters 24. This A/D conversion process is done periodically to produce a series of digital values sampled at a periodic interval that represents the useful information of the sensor. Such information can be used for maintenance purposes. Engine sensors are attached to the engine subsystem where a parameter is measured. The sensors are attached to the engine or engine subsystem and usually have wires emerging from the sensor to conduct the signal to the control system or information recording system. Engine sensors may have continuous analog signals where there is a linear or logarithmic or other mathematical relationship between the parameter being sensed and the amplitude of the signal produced by the sensor. Alternatively, some sensors may have discrete signals where the signal has a finite number of states. An example of a discrete signal includes a switch to detect that the lubricant level is acceptable or not. Such a level sensor has two discrete states. Also, engine sensors may include a sensor that produces one single pulse for every rotation of the engine's crankshaft. Such a sensor has a signal with two discrete states; off for most of the rotation and on for a brief portion of the rotation at a particular point in the rotation. The period of such a signal determines the rotational speed of the engine. Also, the pulse of such a signal may be the basis for timing engine operations that must occur at specific points of the engine rotation. Collectively, the engine sensors are mechanical and electromechanical devices that are installed in various locations of the engine(s) and are electrically connected to signal conditioners and processors through wires and cables. Engine operating parameters may be sensed by recognizing instruments and gauges that display such parameters to the flight staff. The recognition process may be based on a camera that is capturing images of instruments and gauges. The camera may be a camera that is part of the system to capture images of the aircraft in operation where the gauges and instruments are recognized and converted to digital values by the circuits for signal processing.

Aircraft sensor devices 23 are used to sense the operational characteristics of the aircraft. These sensors include both analog and digital sensing devices used to sense such parameters as location (longitude and latitude), altitude, heading direction, airspeed, time, date, inside and outside air temperature, and other environmental characteristics. Analog aircraft sensors convert parameters such as temperature and pressure into low-level analog signals through amplification and filtering. The conditioned analog signals are converted to digital values using Analog to Digital (A/D) converters. The analog signals are converted to digital values periodically resulting in a series of digital values that, together, contain the useful information of a sensor. Digital sensors are used primarily in the form of sensing location (longitude and latitude) using the Global Positioning System (GPS) to compute location. In the GPS, a sensing module receives signals that are transmitted from satellites, and these signals are decoded, compared, and processed to produce a digital data set that indicates the location of the module at that instant. The GPS module periodically emits a series of digital values that represent the current location. Collectively, the aircraft sensors are mechanical and electromechanical devices that are installed in various locations of the aircraft and are electrically connected to signal conditioners and processors through wires and cables. Aircraft operating parameters may be sensed by recognizing instruments and gauges that display such parameters to the flight staff. The recognition process may be based on a camera that is capturing images of instruments and gauges. The camera may be a camera that is part of the system to capture images of the aircraft in operation where the gauges and instruments are recognized and converted to digital values by the circuits for signal processing.

Each of the analog sensors (20, 21, 22, and 23) may be processed by signal conditioners including amplification of low-level signals, spectral filtering, and conversion to digital values by Analog to Digital Converters (A/D) 24. In some cases, the signal conditioners are an integral component of the sensor and are physically located within or adjacent to the sensor. In other cases, the signal conditioners are integrated within components of the recording system that are located away from the sensor. In all cases, electrical cables are used to conduct the conditioned or non-conditioned signal to devices that will perform the analog to digital conversion and further processing leading up to digital recording.

The series of digital values that represent the information content of the sensor may or may not be processed further by a digital signal processor 25. The digital signal processor(s) are programmable integrated circuits that have the ability to receive a series of digital values representing the information content of a signal and to enhance that information content. Enhancement may consist of compression (reduction of the quantity of data required to represent a good quality of information), recognition of features, and other forms of improvement. The digital signal processor(s) are integrated circuits that are mounted on Printed Circuit Boards (PCB's.) These circuit boards include memory, input and output, and supporting integrated circuits. These circuit boards are enclosed in packages that contain the circuits, wiring, power management, and interconnections necessary for an electromechanical package housing such devices.

The digital signal processor functions 25 are implemented with integrated circuits on printed circuit boards where the processor functionality is implemented in programs stored in memory. The programs include such functions as data compression, signal filtering or enhancement, and decisions about which data to record and how to record the data. These are programs that are software implemented in the programming language of the digital signal processor. These programs are changeable by reprogramming through changing memory circuits or transferring from one memory medium to another. This may be accomplished by opening the electronics enclosures to reveal the integrated circuits and changing memory circuits, or by communicating a new program data block to the digital signal processor board through one of many existing input/output connections.

The information from the camera may be processed further to remove or “blank” a segment of an image. This segment removal permits the capture of a scene with the removal of a section of the scene where that section is deemed “private.” The section removed may hide the image of a person, thereby protecting the person's privacy. Also the section removed may include the image of equipment or facilities that are deemed private. The ability to process images in a manner to remove a segment is performed in software or programmable logic. This software may execute on the same integrated circuits used for digital signal processing or the blanking software may have integrated circuits solely for the purpose of blanking. In either case, the logic to perform blanking is programmable and can be modified with either a memory change or by the loading of new programs into existing memory or logic integrated circuits.

Blanking may take the form of modifying the pixels in a region into a pure color such as black, white, or gray. Also, blanking may modify the pixels of the region by substituting a pattern such a hash marks or random pixel values. Whatever technique is used, the objective is to distort the images of a region to the point that the original image of that region is not recognizable even through extensive efforts to analyze the pixels.

The recorded information that has been processed through signal processing, compression and blanking may be encrypted prior to storage or transmission. The process of encryption modifies the digital data of the recording so that the recording may only be viewed by a viewer possessing a digital “key.” The encryption process causes the digital data of the recording to be processed by an encryption device to produce encrypted data. The encrypted data is meaningless without a correct decryption key.

The device to perform the encryption process may be the same device that performs the digital signal processing, data compression, and segment blanking. Alternatively, a device may be dedicated to perform the encryption process. The device to perform the encryption may be either a general purpose computer Central Processing Unit (CPU), a specific purpose computer such as a Digital Signal Processor (DSP), or special purpose circuits. In all of these cases, the device to perform the encryption process is one or more integrated circuits on Printed Circuit Boards (PCB's.) The device(s) to perform the encryption process is connected to the other function with connections on a PCB or through cables and connectors. The device to perform the encryption process may be programmable to implement various algorithms or the device to perform the encryption process may be dedicated circuits which are unchangeable. The device to perform the encryption process contains memory that holds the encryption key, and the encryption key is programmable.

The processed, compressed, and encrypted recorded data is either transmitted to another system for storage, or it is stored aboard the aircraft. The device to perform the data transmission is an aviation telecommunications system. This device uses Radio Frequencies (RF) to perform a bit-serial data transfer from the aircraft to another aircraft or to a ground receiver. The aviation telecommunications system includes electronics packages to process the transmitted and received data at high data rates. It includes mechanical packages for circuit boards containing integrated circuits that perform the data buffering, data manipulation, transmit signal modulation, and receive signal demodulation. The aviation telecommunications system includes one or more antennas for both transmit and receive. The telecommunications electronics, antennae, and the recording systems are mounted to the aircraft chassis and interconnected with cables and connectors.

The on-board data storage for the recorded information can have many forms. The data storage can be memory semiconductor integrated circuits mounted on Printed Circuit Boards (PCB's.) This can include volatile semiconductor memory that looses its data when power is removed, or it can be non-volatile semiconductor memory such as FLASH or EEPROM (Electrically Erasable Read Only Memory.) The data storage can include non-volatile digital data storage devices such as rotating disks (magnetic or optical.) The data storage device can include non-volatile storage devices such as analog or digital magnetic tape. The on-board data storage may be configured as a non-volatile device that can survive the crash of an airplane. The data recording may be made for the purpose of accident investigation, in which case it would be valuable to store the most recent recordings in a device where the memory survives the crash. In such a case, Accident Investigators could find the crash-survivable memory following a crash, and extract the data from the memory to reconstruct the events leading up to the crash. Any of these memory devices would consist of electronics and electromechanical devices in enclosures mounted to the aircraft chassis and connected to other aircraft systems with wires and connectors.

We claim:

1) A method and apparatus to record and process aircraft operations information comprising:
a) a means to sense operational conditions and situations as a variety of signals,
b) a means to convert the sensed signals to digital data using both intelligent processes and non-intelligent processes,
c) and a means to process the digital data into a form that can be stored temporarily in the available memory aboard the airplane.

2) A method and apparatus to record and process aircraft operations information comprising:
a) a means to sense operational conditions and situations as a variety of signals,
b) a means to convert the sensed signals to digital data using both intelligent processes and non-intelligent processes,
c) and a means to process the digital data into a form that can be transmitted using wireless communications conforming to the available bandwidth.

3) A method and apparatus to record and process aircraft operations information comprising:
a) a means to sense operational conditions and situations as a variety of signals,
b) a means to convert the sensed signals to digital data using both intelligent processes and non-intelligent processes,
c) a means to process the digital data into a form that can be stored temporarily in the available memory aboard the airplane,
d) and a means to process the digital data into a form that can be transmitted using wireless communications conforming to the available bandwidth.

4) The method and apparatus of claim 1 wherein the signals sensed may include, but are not limited to:
a) engine operation parameters such as speed, fuel and lubrication parameters, operating temperatures, and maintenance history,
b) aircraft operation parameters such as speed, heading, location, altitude, and maintenance history,
c) audio communications among aircraft personnel, audible communications between aircraft personnel and passengers, and audible communications between aircraft personnel and ground personnel,
d) images of aircraft personnel and their actions, images of passengers and their actions, and images of equipment inside and outside of the aircraft and the actions of said equipment where said images are captured from either analog video camera(s) or digital camera(s).

5) The method and apparatus of claim 2 wherein the signals sensed may include, but are not limited to:
a) engine operation parameters such as speed, fuel and lubrication parameters, operating temperature, and maintenance history,
b) aircraft operation parameters such as speed, heading, location, altitude, and maintenance history,
c) audio communications among aircraft personnel, audible communications between aircraft personnel and passengers, and audible communications between aircraft personnel and ground personnel,
d) images of aircraft personnel and their actions, images of passengers and their actions, and images of equipment inside and outside of the aircraft and the actions of said equipment.

6) The method and apparatus of claim 3 wherein the signals sensed may include, but are not limited to:
a) engine operation parameters such as speed, fuel and lubrication parameters, operating temperature, and maintenance history,
b) aircraft operation parameters such as speed, heading, location; altitude, and maintenance history,
c) audio communications among aircraft personnel, audible communications between aircraft personnel and passengers, and audible communications between aircraft personnel and ground personnel,
d) images of aircraft personnel and their actions, images of passengers and their actions, and images of equipment inside and outside of the aircraft and the actions of said equipment.

7) The method and apparatus of claim 1 wherein the digital data is in part or in total compressed to reduce the quantity of memory required for storage.

8) The method and apparatus of claim 2 wherein the digital data is in part or in total compressed to conform to the available bandwidth for transmission.

9) The method and apparatus of claim 3 wherein the digital data is in part or in total compressed to reduce the quantity of memory required for storage and to conform to the available bandwidth for transmission.

10) The method and apparatus of claim 1 wherein the digital data is in part or in total encrypted to prevent unauthorized reading or viewing from the memory aboard the airplane.

11) The method and apparatus of claim 2 wherein the digital data is in part or in total encrypted to prevent unauthorized reading or viewing from the data transmission.

12) The method and apparatus of claim 3 wherein the digital data is in part or in total encrypted to prevent unauthorized reading or viewing from either the memory aboard the airplane or the data transmission.

13) The method and apparatus of claim 1 wherein the digital data is in part or in total compressed to reduce the quantity of memory required for storage, and wherein the digital data is in part or in total encrypted to prevent unauthorized reading or viewing from the memory aboard the airplane.

14) The method and apparatus of claim 2 wherein the digital data is in part or in total compressed to conform to the available bandwidth for transmission, and wherein the digital data is in part or in total encrypted to prevent unauthorized reading or viewing from the data transmission.

15) The method and apparatus of claim 3 wherein the digital data is in part or in total compressed to reduce the quantity of memory required for storage and to conform to the available bandwidth for transmission, and wherein the digital data is in part or in total encrypted to prevent unauthorized reading or viewing from either the memory aboard the airplane or the data transmission.

16) The method and apparatus of claim 1 wherein a portion or all of the digital images have specified regions removed or “blanked” to assure privacy of specific individuals.

17) The method and apparatus of claim 2 wherein a portion or all of the digital images have specified regions removed or “blanked” to assure privacy of specific individuals.

18) The method and apparatus of claim 3 wherein a portion or all of the digital images have specified regions removed or “blanked” to assure privacy of specific individuals.

19) The method and apparatus of claim 7 wherein a portion or all of the digital images have specified regions removed or “blanked” to assure privacy of specific individuals.

20) The method and apparatus of claim 8 wherein a portion or all of the digital images have specified regions removed or “blanked” to assure privacy of specific individuals.

21) The method and apparatus of claim 9 wherein a portion or all of the digital images have specified regions removed or “blanked” to assure privacy of specific individuals.

22) The method and apparatus of claim 10 wherein a portion or all of the digital images have specified regions removed or “blanked” to assure privacy of specific individuals.

23) The method and apparatus of claim 11 wherein a portion or all of the digital images have specified regions removed or “blanked” to assure privacy of specific individuals.

24) The method and apparatus of claim 12 wherein a portion or all of the digital images have specified regions removed or “blanked” to assure privacy of specific individuals.

25) The method and apparatus of claim 13 wherein a portion or all of the digital images have specified regions removed or “blanked” to assure privacy of specific individuals.

26) The method and apparatus of claim 14 wherein a portion or all of the digital images have specified regions removed or “blanked” to assure privacy of specific individuals.

27) The method and apparatus of claim 15 wherein a portion or all of the digital images have specified regions removed or “blanked” to assure privacy of specific individuals.

28) The method and apparatus of claim 2 wherein the wireless transmission may include, but is not limited to:
a) direct point-to-point (line of sight) Radio Frequency (RF) communications including, but not limited to, Amplitude Modulation (AM) and Frequency Modulation (FM),
b) satellite relay Radio Frequency (RF) communications including, but not limited to, Amplitude Modulation (AM) and Frequency Modulation (FM),
c) and modulated infrared optical communications.

29) The method and apparatus of claim 3 wherein the wireless transmission may include, but is not limited to:
a) direct point-to-point (line of sight) Radio Frequency (RF) communications including, but not limited to, Amplitude Modulation (AM) and Frequency Modulation (FM),
b) satellite relay Radio Frequency (RF) communications including, but not limited to, Amplitude Modulation (AM) and Frequency Modulation (FM),
c) and modulated infrared optical communications.

30) The method and apparatus of claim 2 wherein the wireless transmission includes flight operational data from the aircraft to the ground station, and also includes control information from the ground station to the aircraft.

31) The method and apparatus of claim 3 wherein the wireless transmission includes flight operational data from the aircraft to the ground station, and also includes control information from the ground station to the aircraft.

32) The method and apparatus of claim 2 wherein the transmitter and/or receiver of the wireless transmission may include, but is not limited to:
a) the data controller aboard the airplane,
b) a centralized ground station controller,
c) distributed ground station controllers including, but not limited to, NTSB, FAA flight control centers, airline offices, airplane manufacturer's offices, and security offices, such as the FBI, NSA, CIA, and others,
d) passengers aboard the airplane including, but not limited to, a Federal Marshall,
e) other airplanes both on the ground and in-flight.

33) The method and apparatus of claim 3 wherein the transmitter and/or receiver of the wireless transmission may include, but is not limited to:
a) the data controller aboard the airplane,
b) a centralized ground station controller,
c) distributed ground station controllers including, but not limited to, NTSB, FAA flight control centers, airline offices, airplane manufacturer's offices, and security offices, such as the FBI, NSA, CIA, and others,
d) passengers aboard the airplane including, but not limited to, a Federal Marshall,
e) other airplanes both on the ground and in-flight.

34) The method and apparatus of claim 4 wherein the audio signals recorded include, but are not limited to:
a) sounds in the normal audible human hearing range sensed by a microphone,
b) vibrations of air or other medium in frequency ranges below normal audible human hearing range sensed by a vibration sensor,
c) vibrations of air or other medium in frequency ranges above normal audible human hearing range sensed by a vibration sensor,

35) The method and apparatus of claim 5 wherein the audio signals recorded include, but are not limited to:
a) sounds in the normal audible human hearing range sensed by a microphone,
b) vibrations of air or other medium in frequency ranges below normal audible human hearing range sensed by a vibration sensor,
c) vibrations of air or other medium in frequency ranges above normal audible human hearing range sensed by a vibration sensor,

36) The method and apparatus of claim 6 wherein the audio signals recorded include, but are not limited to:
a) sounds in the normal audible human hearing range sensed by a microphone,
b) vibrations of air or other medium in frequency ranges below normal audible human hearing range sensed by a vibration sensor,
c) vibrations of air or other medium in frequency ranges above normal audible human hearing range sensed by a vibration sensor,

37) The method and apparatus of claim 4 wherein the images recorded include, but are not limited to two-dimensional images:
a) produced from sensors sensitive to monochrome visible light reflected from the subject,
b) produced from sensors sensitive to color visible light reflected from the subject,
c) produced from sensors sensitive to monochrome infrared light reflected and/or emitted from the subject,
d) produced from sensors sensitive to other non-visible light sources, such as X-Ray.

38) The method and apparatus of claim 5 wherein the images recorded include, but are not limited to two-dimensional images:
a) produced from sensors sensitive to monochrome visible light reflected from the subject,
b) produced from sensors sensitive to color visible light reflected from the subject,
c) produced from sensors sensitive to monochrome infrared light reflected and/or emitted from the subject,
d) produced from sensors sensitive to other non-visible light sources, such as X-Ray.

39) The method and apparatus of claim 6 wherein the images recorded include, but are not limited to two-dimensional images:
a) produced from sensors sensitive to monochrome visible light reflected from the subject,
b) produced from sensors sensitive to color visible light reflected from the subject,
c) produced from sensors sensitive to monochrome infrared light reflected and/or emitted from the subject,
d) produced from sensors sensitive to other non-visible light sources, such as X-Ray.

40) The method and apparatus of claim 1 wherein the images recorded include the ability to mechanically pan, tilt, and zoom of the camera.

41) The method and apparatus of claim 2 wherein the images recorded include the ability to mechanically pan, tilt, and zoom of the camera.

42) The method and apparatus of claim 3 wherein the images recorded include the ability to mechanically pan, tilt, and zoom of the camera.

43) The method and apparatus of claim 1 wherein the images recorded include the ability to electronically pan, tilt, and zoom of the camera.

44) The method and apparatus of claim 2 wherein the images recorded include the ability to electronically pan, tilt, and zoom of the camera.

45) The method and apparatus of claim 3 wherein the images recorded include the ability to electronically pan, tilt, and zoom of the camera.

46) The method and apparatus of claim 1 wherein the images recorded include the ability to perform any combination of electronic and mechanical pan, tilt, and zoom of the camera.

47) The method and apparatus of claim 2 wherein the images recorded include the ability to perform any combination of electronic and mechanical pan, tilt, and zoom of the camera.

48) The method and apparatus of claim 3 wherein the images recorded include the ability to perform any combination of electronic and mechanical pan, tilt, and zoom of the camera.
